(19) United States
(12) Patent Application Publication
(10) Pub. No.: US 2026/0070075 A1
(43) Pub. Date: Mar. 12, 2026

(54) Reusable Spraying Apparatus with Detachable Cleaning Tablet Storage Compartment

(71) Applicant: Joseph Dana, West Long Branch, NJ (US)

(72) Inventor: Joseph Dana, West Long Branch, NJ (US)

(21) Appl. No.: 18/883,867

(22) Filed: Sep. 12, 2024

(51) Int. Cl. B05B 11/00

(52) U.S. Cl. CPC B05B 11/0081

(57) ABSTRACT

A reusable spraying apparatus comprises a spray bottle having a main body portion defining a liquid reservoir, a spray head coupled to the main body portion with an adjustable nozzle, and a detachable base portion removably secured to the main body portion. The detachable base portion defines a storage compartment configured to hold at least one solid cleaning tablet that dissolves in water to form a cleaning solution. The storage compartment is separate from the liquid reservoir, allowing for replenishment of the cleaning solution as needed. The spray head may be pivotally coupled to allow adjustable nozzle angling and the nozzle may be adjustable between spray and stream modes. The spraying apparatus provides a refillable, customizable, and cost-effective cleaning system that reduces waste associated with conventional disposable spray bottles.

### BACKGROUND OF THE INVENTION

### Field of Invention

The various aspects discussed herein relate to the field of spray bottles and cleaning systems. More specifically, the present disclosure is directed to a refillable and reusable spray bottle apparatus that utilizes solid cleaning tablets.

### Description of Related Art

Provide Background on the field of technology, if known] Conventional spray bottles are commonly used for dispensing cleaning solutions and other household liquids. However, these spray bottles suffer from several drawbacks. The cleaning solutions are typically sold pre-mixed in disposable plastic bottles, leading to excess waste and a lack of customization or versatility. When empty, the bottles must be discarded and new bottles purchased, even if the spray mechanisms remain functional. Additionally, the need to purchase pre-mixed solutions can be costly over time and requires significant storage space.

Accordingly, there exists a need for an improved, refillable spraying apparatus that addresses the problems associated with conventional disposable spray bottles. Such a spraying apparatus would beneficially allow a user to customize their cleaning solutions, reduce plastic waste, and provide a more convenient and cost-effective approach to household cleaning. The present disclosure is directed to addressing these needs in the art.

### BRIEF SUMMARY OF THE INVENTION

This summary is provided to introduce a selection of concepts, in a simplified format, that are further described in the detailed description of the invention. This summary is neither intended to identify key or essential inventive concepts of the invention nor is it intended for determining the scope of the invention.

The present disclosure is directed to a reusable spraying apparatus that addresses the limitations of conventional disposable spray bottles. In one aspect, the spraying apparatus comprises a spray bottle having a main body portion defining a liquid reservoir, a spray head coupled to the main body portion with a nozzle for dispensing a cleaning solution, a detachable base portion removably secured to the bottom end of the main body portion that defines a storage compartment, and at least one cleaning tablet disposed within the storage compartment that is configured to dissolve in water to form the cleaning solution.

The detachable base portion can hold a plurality of solid cleaning tablets in the storage compartment, which is separate from the liquid reservoir. The cleaning tablets may be formulated for various purposes such as glass cleaning, bathroom cleaning, or general purpose cleaning. The detachable base portion may be threadably coupled to the main body portion and include a sealing element to prevent leakage.

The reusable spraying apparatus comprises a refillable cleaning system with the spray bottle having the liquid reservoir and the removable base with the sealed compartment holding the solid cleaning tablets. The cleaning tablets can be introduced into the reservoir and dissolved to replenish the cleaning liquid as needed.

In one embodiment, the spray head is pivotally coupled to allow adjustable nozzle angling and the nozzle is adjustable between spray and stream modes. The spraying apparatus may further include a label with instructions for using the cleaning tablets and the main body portion may be transparent or translucent for visual inspection of the solution level. A locking mechanism may also secure the detachable base portion to the main body portion.

This refillable configuration with the cleaning tablets solves the problems associated with conventional disposable spray bottles by reducing waste, allowing customization, and providing a cost-effective, space-saving, and versatile approach to household cleaning. These and other features and advantages of the invention will be apparent from the foregoing and the more detailed description that follows.

Additional features and advantages of the invention will be set forth in the description which follows. These and other features of the present invention will become more fully apparent from the following description, or may be learned by the practice of the invention as set forth hereinafter.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 is a perspective view of the reusable spraying apparatus, showing the detachable base portion removed from the main body portion, according to one embodiment.

FIG. 2 is a lateral view of the main body portion and spray head 106 of the spraying apparatus, according to one embodiment.

FIG. 3 is a top view of the detachable base portion of the spraying apparatus, according to one embodiment.

FIG. 4 is a lateral cross-sectional view of the detachable base portion, revealing interior features, according to one embodiment.

### DETAILED DESCRIPTION

In the following detailed description of the preferred embodiments, reference is made to the accompanying drawings, which form a part hereof and show, by way of illustration, specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

The following description is provided as an enabling teaching of the present systems, and/or methods in its best, currently known aspect. To this end, those skilled in the relevant art will recognize and appreciate that many changes can be made to the various aspects of the present systems described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The terms “a” and “an” and “the” and similar references used in the context of describing a particular embodiment of the present invention (especially in the context of certain claims) are construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein.

All systems described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word or as used herein means any one member of a particular list and also includes any combination of members of that list. Further, one should note that conditional language, such as, among others, “can,” “could,” “might”, or “may” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

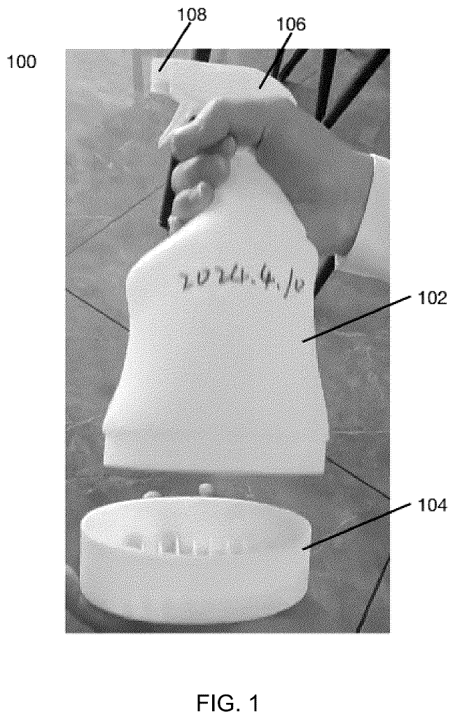

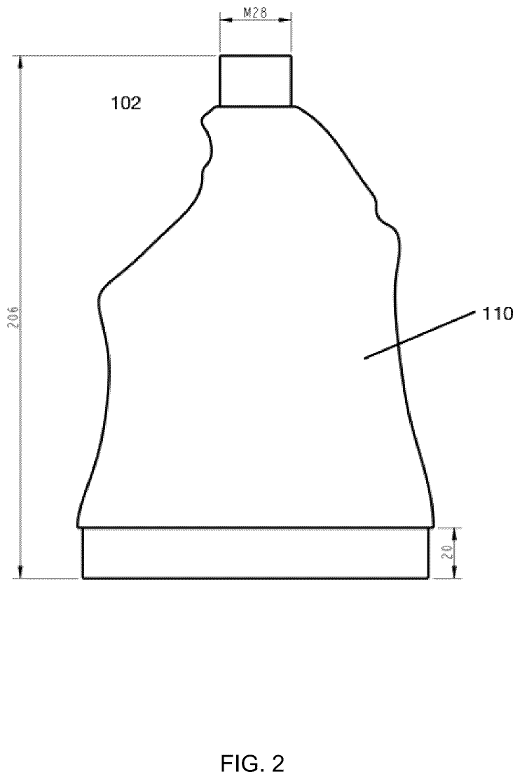

FIG. 1 is a perspective view of the reusable spraying apparatus 100, showing the detachable base portion 104 removed from the main body portion 102. In one embodiment, the main body portion 102 defines a liquid reservoir 110 (See FIG. 2) for holding a cleaning solution. The spray head 106 is coupled to a first end of the main body portion 102 and includes a nozzle 108 in fluid communication with the liquid reservoir 110 for dispensing the cleaning solution. In another embodiment, the detachable base portion 104 is configured to be removably secured to a second end of the main body portion 102 opposite the first end, wherein the detachable base portion 104 defines a storage compartment 112 for holding at least one cleaning tablet (not shown). The at least one cleaning tablet (not shown) is configured to dissolve in water within the liquid reservoir 110 to form the cleaning solution for dispensing through the nozzle 108. In one embodiment, the spray head 106 is shown pivotally coupled to the main body portion 102 via pivot joint 116, thereby allowing for adjustable angling of the nozzle 108. In one embodiment the nozzle 108 is adjustable between a spray mode and a stream mode.

FIG. 2 is a cross sectional lateral view of the main body portion 102 and spray head 106 of the spraying apparatus 100. In some embodiments, a label (not shown) is affixed to an outer surface of the main body portion 102, providing instructions for using the at least one cleaning tablet (not shown) to form the cleaning solution within the liquid reservoir 110. The main body portion 102 is composed of a transparent or translucent material, thereby allowing for visual inspection of the cleaning solution level within the liquid reservoir 110.

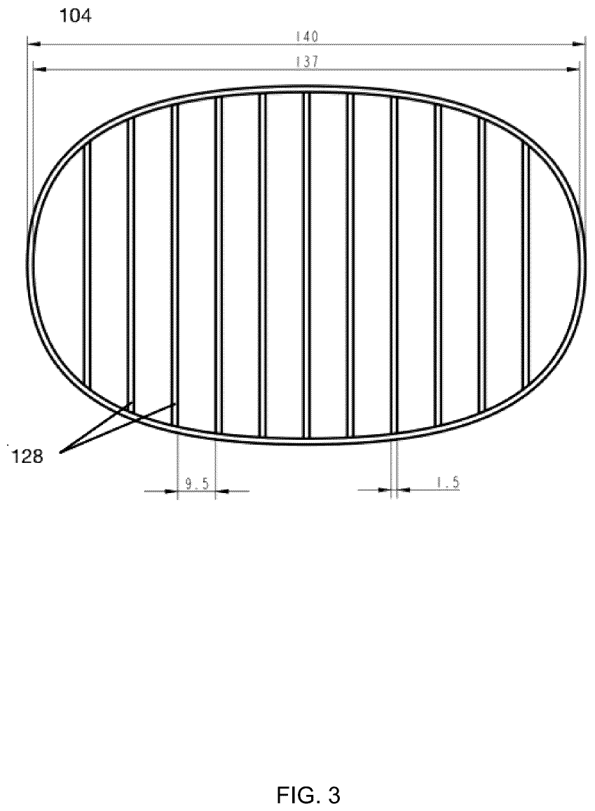

FIG. 3 is a top view of the detachable base portion 104 of the spraying apparatus 100. In one embodiment, the storage compartment 112 defined within the detachable base portion 104 is configured to hold a plurality of cleaning tablets (not shown) wherein the cleaning tablets (not shown) may be selected from various types, comprising a glass cleaning tablet, a bathroom cleaning tablet, and a general purpose cleaning tablet. In some embodiments the detachable base portion 104 includes a locking mechanism (not shown) comprising threads that mate with corresponding threads on the second end of the main body portion 102, thereby allowing the detachable base portion 104 to be threadably coupled to the main body portion 102.

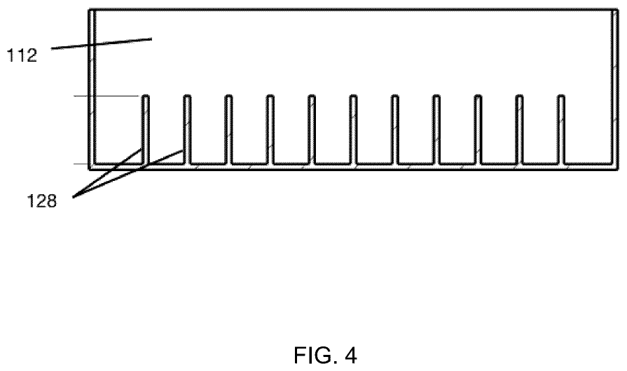

FIG. 4 is a lateral cross-sectional view of the detachable base portion 104, revealing interior features. In one embodiment, the storage compartment 112 can hold the plurality of cleaning tablets (not shown) in a stacked configuration, wherein the storage compartment 112 is sealed and separate from the liquid reservoir 110 in the main body portion 102 when the detachable base portion 104 is secured to the spraying apparatus 100. The interior surface of the storage compartment 112 includes ridges 128 configured to secure the cleaning tablets (not shown) in place.

In some embodiments, the reusable spraying apparatus 100 is a handheld device that provides a refillable cleaning system, wherein the solid cleaning tablets (not shown) stored in the detachable base portion 104 are configured to be introduced into the liquid reservoir 110 and dissolved in water to replenish the cleaning solution as needed. The storage compartment 112 in the detachable base portion 104 provides a convenient location to store the cleaning tablets 114 when not in use, while keeping them separate from the liquid reservoir 110 to avoid premature dissolution. In one embodiment, the pivoting spray head 106 and adjustable nozzle 108 allow the user to control the spray pattern and direction of the cleaning solution during use. The transparent or translucent main body portion 102 enables easy monitoring of the cleaning solution level, while the label (not shown) provides clear instructions for refilling the spraying apparatus 100 using the cleaning tablets 114.

The embodiments described herein are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. A reusable spraying apparatus comprising:
a. a spray bottle having a main body portion defining a liquid reservoir;
b. a spray head coupled to the main body portion, the spray head including a nozzle in fluid communication with the liquid reservoir for dispensing a cleaning solution;
c. a detachable base portion removably secured to a bottom end of the main body portion, the detachable base portion defining a storage compartment; and
d. at least one cleaning tablet disposed within the storage compartment, wherein said at least one cleaning tablet is configured to dissolve in water to form the cleaning solution in the liquid reservoir.

2. The reusable spraying apparatus of claim 1, wherein the storage compartment is configured to hold a plurality of cleaning tablets.

3. The reusable spraying apparatus of claim 1, wherein the at least one cleaning tablet is selected from the group consisting of a glass cleaning tablet, a bathroom cleaning tablet, and a general purpose cleaning tablet.

4. The reusable spraying apparatus of claim 1, wherein the detachable base portion is threadably coupled to the bottom end of the main body portion.

5. The reusable spraying apparatus of claim 1, wherein the spray head is pivotally coupled to the main body portion, allowing for adjustable angling of the nozzle.

6. The reusable spraying apparatus of claim 1, wherein the nozzle is adjustable between a spray mode and a stream mode for dispensing the cleaning solution.

7. The reusable spraying apparatus of claim 1, further comprising a label affixed to the main body portion, the label providing instructions for using the at least one cleaning tablet to form the cleaning solution.

8. The reusable spraying apparatus of claim 1, wherein the main body portion is composed of a transparent or translucent material, allowing for visual inspection of the cleaning solution level within the liquid reservoir.

9. The reusable spraying apparatus of claim 1, wherein the detachable base portion includes a locking mechanism to securely engage with the bottom end of the main body portion.

10. A refillable cleaning system comprising:
a. a handheld spray bottle including:
b. a body having a first end and a second end, the body defining an internal volume for holding a cleaning liquid;
c. a spray head attached to the first end of the body, the spray head having a nozzle fluidly connected to the internal volume for spraying the cleaning liquid; and
d. a removable base attached to the second end of the body, the removable base forming a sealed compartment separate from the internal volume; and
e. a plurality of solid cleaning tablets contained within the sealed compartment of the removable base, each of the plurality of solid cleaning tablets configured to be introduced into the internal volume and dissolved in water to replenish the cleaning liquid.

11. The refillable cleaning system of claim 10, wherein the body is composed of a transparent or translucent material, allowing for visual inspection of a cleaning liquid level within the internal volume.

12. The refillable cleaning system of claim 10, wherein the spray head is pivotally attached to the first end of the body, allowing for adjustable angling of the nozzle.

13. The refillable cleaning system of claim 10, wherein each of the plurality of solid cleaning tablets is selected from the group consisting of a glass cleaning tablet, a bathroom cleaning tablet, and a general purpose cleaning tablet.

14. The refillable cleaning system of claim 10, wherein the removable base is threadably coupled to the second end of the body.

15. The refillable cleaning system of claim 10, wherein the nozzle is adjustable between a spray mode and a stream mode for spraying the cleaning liquid.

16. The refillable cleaning system of claim 10, further comprising a label affixed to the body, the label providing instructions for using each of the plurality of solid cleaning tablets to replenish the cleaning liquid.

17. The refillable cleaning system of claim 10, wherein the removable base includes a locking mechanism to securely engage with the second end of the body.

18. The refillable cleaning system of claim 10, wherein the sealed compartment is configured to hold the plurality of solid cleaning tablets.
